(19) United States
(12) Patent Application Publication
(10) Pub. No.: US 2014/0037090 A1
(43) Pub. Date: Feb. 6, 2014

(54) SYSTEM AND METHOD OF DIGITAL RIGHTS MANAGEMENT

(71) Applicant: JASON FREDERICK NICHOLLS, Pretoria (ZA)

(72) Inventor: JASON FREDERICK NICHOLLS, Pretoria (ZA)

(73) Assignee: Media Speed Tech LLC, a Delaware limited liability company

(21) Appl. No.: 13/567,838

(22) Filed: Aug. 6, 2012

(51) Int. Cl. H04N 7/167

(52) U.S. Cl. 380/201; 380/200

(57) ABSTRACT

A method and a system of digital right management on a computer system. Protected video content is decrypted where encoded frames of data are buffered and overwritten after decoding to prevent the unauthorized copying. The system includes a software client that has a user identifiable key for tracing any unauthorized copying of the client and decrypted video file.

### FIELD OF THE INVENTION

This invention relates generally to systems and methods of digital rights management for digital content. Specifically, a method of securely storing digital content to be executed or displayed and prevents unauthorized copying of the digital content while limiting access to a single user or system.

### BACKGROUND

Currently physical digital media, such as DVD's, are protected with embedded DRM (Digital Rights Management). Games and movies are provided on a DVD or a CD are encoded in such that the application or video and audio content cannot be transferred from one media to another.

The problem with unprotected content is that once downloaded, the digital content can be written to any device (DVD, CD, Memory Stick) or uploaded to network storage. The content is available for anyone to access, execute or play and thus the economic value of the video content is diminished.

To prevent this copying, the streaming of movies and audio are buffered inside a secure communication channel. However, this limits the viewing of video to when a user is on-line when the digital communication stream is open with a streaming service. What are needed is a device, system, and method that protects stored digital content from copying while allowing the content to be played or executed while not connected to a streaming service.

### BRIEF DESCRIPTION OF THE DRAWINGS

FIG. 1 is a process diagram of one method of digital rights management.

FIG. 2 is a process diagram of a second embodiment of a method of digital rights management.

FIG. 3 is a block diagram of a system embodiment for implementing digital rights management.

FIG. 4 is a diagram of the encoding relationship between the different types of MPEG frames.

FIG. 5 is a diagram of the order of decoding MPEG frames.

FIG. 6 is a diagram of an embodiment of the memory buffer organization.

### SUMMARY OF THE INVENTION

In one aspect of the invention a method of digital rights management on a computer is disclosed. The method comprises a step of decrypting a first encoded frame of encoded video from an encrypted digital video source into a memory buffer. In one embodiment, public-key encryption is used to encode the data but other encryption methods can be used.

Access to the memory buffer is provided to a video decoder. In some embodiments, access to the buffer is by memory reference and in other embodiments access is by copying the memory buffer.

The encoded frame, loaded into the memory buffer, is decoded thus forming a decoded frame. The encoded frame can comply with the encoding standards of MPEG-2, MPEG-4, MPEG-4 AVC, H.264, AVI, or the streaming encoding standard including but not limited to H.263. The encoded and decoded frames can be I-frames, P-frames, and B-frames.

Upon decoding the encoded frame, it is altered such that the encoded frame cannot be decoded. In one embodiment, the alteration is by overwriting the frame with a new encoded frame. In another embodiment, the alteration is by overwriting critical information in the encoded frame.

In one embodiment, the decoder provides an indication that the encoded frame is decoded. The indication includes but is not limited to functional returns, functional return parameters, operating system messaging, memory flags, and semaphores.

In another aspect of the invention, a second method of digital rights management on a computer is disclosed. The method comprises a step of decrypting one or more encoded frames of video from an encrypted digital video source into a memory buffer. One or more of the decrypted encoded frames are decoded using the one or more encoded frames in the memory buffer. After decoding the encoded frames, the encoded frames in the memory buffer are altered.

In one embodiment, the encoded frame alteration is performed by overwriting the one or more frames with one or more new encoded frames. In another embodiment, the encoded frames are altered such that they cannot be decoded. In a further embodiment, the memory buffer starts with an encoded full frame or I-frame and only this encoded frame is altered such that the encoded frame cannot be decoded.

In some embodiments, public-key encryption is used to encrypt the digital video data including the encoded frame data. In some embodiments, the encoded frame complies with but not limited to one of the video encoding standards for MPEG-2, MPEG-4, MPEG-4 AVC, H.264, AVI, and streaming standard H.263. The decoded frames can be I-frames, P-frames, and B-frames.

In another embodiment, the decoder provides an indication that the encoded frame is decoded. The indication includes functional returns, return parameters, operating system messaging, memory flags, and semaphores.

In another aspect of the current invention, a system for digital rights management is disclosed. The system comprises a computer configured with a client having a unique computer associated decryption key, a computer accessible media source configured with an encrypted encoded video data, a memory buffer configured to hold decrypted encoded frames, and a video decoder. The client is configured to decrypt one encoded frame at a time into the memory buffer, transfer the data to the video decoder, and alter the encoded frame data after transfer to the video decoder or decoding by the decoder.

In one embodiment, the system is configured to decrypt and overwrite the buffer with a second encoded frame after the encoded frame in the buffer is transferred to the video decoder. In some embodiments, the encoded frames are encoded I-frames, P-frames, or B-frames. In some embodiments encoded format complies with the encoding standards for either MPEG-2, MEPG-4, MPEG-4 AVC, H.264, H.263, or AVI standards. In another embodiment, the client is configured to only modify the encoded I-frame after decoding the encoded I-frame.

In another aspect of the current invention, a second system for digital rights management is disclosed. The system comprises a computer configured with a client having a unique computer associated decryption key, a computer accessible media source configured with an encrypted encoded video file, a memory buffer configured to hold decrypted encoded frames, and a video decoder. The client is configured to decrypt, from a digital video source, one or more encoded frames into the memory buffer, decode the encoded frames, and alter one or more of the one or more encoded frames.

In one embodiment, the first encoded frame in the memory buffer is always a fully encoded full video frame or an I-frame. In one embodiment, the altering of the I-frame is by decrypting one or more new encoded frames into the memory buffer. In a further embodiment, the I-frame is modified such that it cannot be decoded. In one embodiment, the first frame in the buffer is always an encoded I-frame.

### DETAILED DESCRIPTION OF THE INVENTION

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognize that many modifications and adaptations to the present invention are possible and can even be desirable in certain circumstances, and are a part of the present invention. Thus, the following description is provided as illustrative of the principles of the present invention and not a limitation thereof.

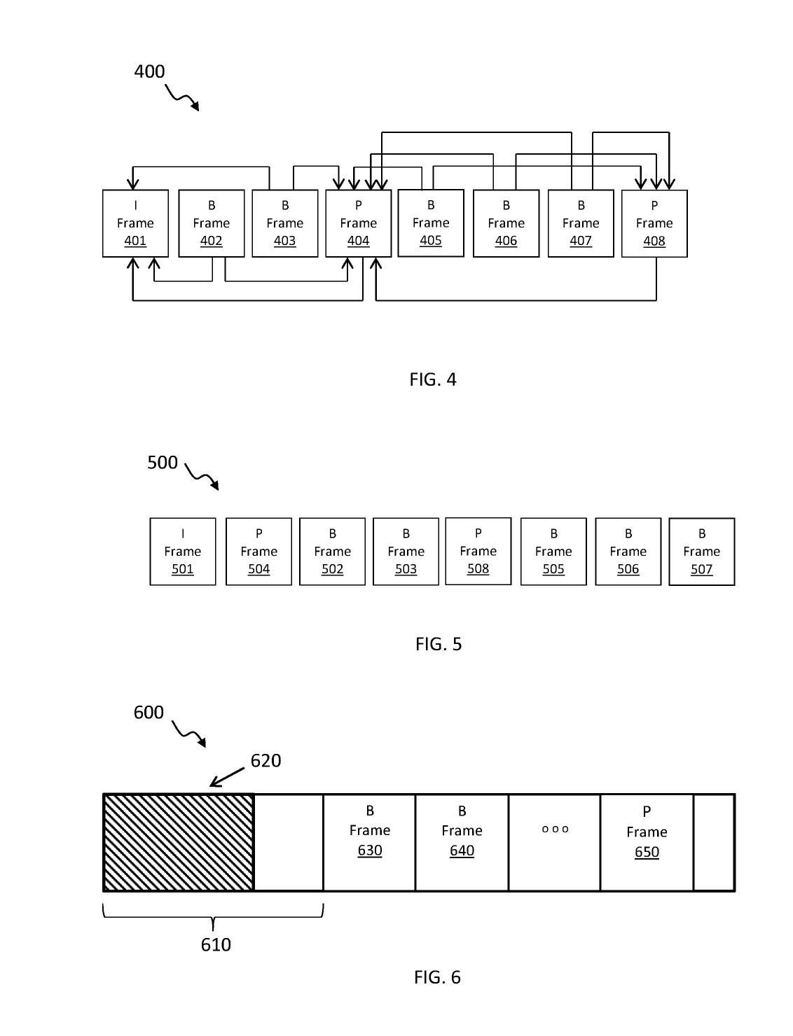

To protect the decrypted video data from copying, the process of decoding encoded video data needs to be understood. The MPEG-2 and MPEG-4 transmits video data as a series of encoded frames that utilize interfame prediction. FIG. 4 shows the relationship between the different types of encoded video frames. Three frame types are typically used in the MPEG video standard. There are I-frames, P-frames, and B-frames. The I-frames or sometimes referred to as an Intra Frames, represents a full frame of video information or slices of a video frame. The P-frames, sometimes referred to as a predicted frames, contains motion estimation based on past I-frames and other past P-frames. The B-frames sometimes referred to as bi-directional predicted frames use past and future I&P frames for predicting motion estimation. More advance standards, such as H.264 can also include the use of past and future I-frames in the motion estimation. About every 12 frames, a new I-frame is transmitted. The number of frames between each I-frame is an encoder configurable parameter and may be more or less than 12. Depending of the application, the MPEG encoder will vary the ratio of P-frames and B-frames and the number of P & B-frames between I-frames.

FIG. 4 also shows a typically sequence of encoded frames for MPEG encode video data. The sequence begins with a full image frame (I-Frame) 401. The following encoded B-frame 402 is based on the I-frame 401 and a subsequent P-frame 404. The P-frame 404 is based on the I-frame 401.

The transmission of the frames occurs in the same order as the frames are generated. This is as shown in FIG. 4. The encoded I-frame 401 is transmitted first. This frame is followed by the two encoded B-frames 402, 403 and followed by the encoded P-frame 404, and so forth. However, the decoding of these frames does not occur in the same order as the frames are received. The encoded B-frame, 402 and 403 cannot be decoded until the P-frame 404 is received and decoded. The encoded B-frames 405, 406, 407 cannot be decoded until the encoded P-frame 404 is received and decode. FIG. 5 shows the order in which frames are decoded.

This out of order decoding effect when the encoded frames can be deleted. While the B-frame 402 is the second frame received or found in a file, this frame cannot be deleted until the P-frame 404 is decoded.

The frame types (I, P, & B) are relevant to the disclosed inventive method and system for digital rights management for several reasons. When decrypting the MPEG file, only the minimum amount of data needed by the MPEG decoder should be decrypted before being overwritten or otherwise altered. Thus, the process of decrypting and overwriting the data needs to know the size and position of each encoded (compressed) I, P, and B-frame in the memory buffer. Further, the process or system needs to be able to determine when the data has been either decoded, or transferred out of a memory buffer so that it can be altered.

Upon decrypting the minimum amount of data, an indication that the data has been utilized can be used to determine when the frame should be overwritten, deleted, or otherwise altered and made non-decodable.

FIG. 6 shows one embodiment of the organization of the buffer 600 holding decrypted encoded frames. The date is decrypted so that the first frame is an I-frame 620. In this embodiment, the buffer allocates enough space 610 to hold the largest I-frame. The remainder of the buffer is filled with B and P-frames 630, 640, 650 up to the next I-frame.

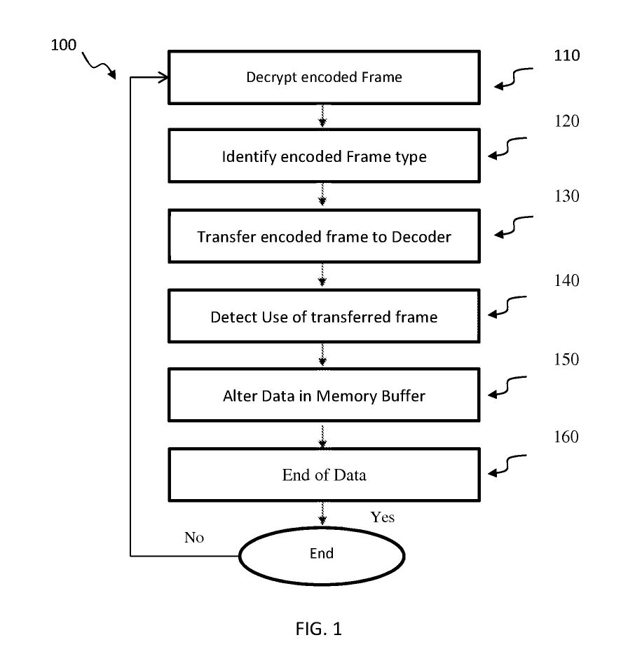

FIG. 1 shows one embodiment of a process of digital rights management of digital video content. In a first step 110, a frame of encoded digital data is decrypted. Preferable the encryption and decryption is based on public-key system. Further, the decoder will search the decrypted data stream to determine the beginning of the encoded frame and its size. The encoded frame is stored in a memory buffer.

In an optional step 120 the encoded frame type is identified. The encoded frame can be an I-frame, a P-frame, or a B-frame. The frame type can be used to know when the frame data can be overwritten or altered to make the buffered encode frame non-usable to unwanted copying.

In a step 130, the frame is transferred to the decoder application. The decoder application will decode the encoded frame. The transfer of the encoded frame data can be by copying the buffered encoded frame or by memory reference to the frame.

In a step 140, release of the transferred frame is detected. The release of buffered an encoded frames use can be by but is not limited to copying the data, decoding of the encoded frame, receiving a message, flag or semaphore through the operating system or a function return value. If the memory buffer with the encoded frame is copied, then the memory buffer can be overwritten or altered as soon as this function is completed.

If the memory with the encoded frame is passed to the decoder by reference, then some frames can not be decoded until subsequent encoded frames are received by the decoder and decoded. Indication of the encoded frame's release, i.e. being decoded, may not occur until several more frames are passed to the decoder. In one embodiment, the indication that a frame has been released can be limited to I-frames. The decoder can immediately decode an encode I-frame. Thus, when the decoder receives an I-frame it should be immediately decoded and the associated encoded frame can then be altered.

In a step 150, the encode frame data is altered so that if an unauthorized a program is able to make a copy of the encoded frame, that either the frame could not be decoded or the decoding would generate an extremely degraded video frame. Radom, changes in the picture would cause the block of data to be missing. A person of ordinary skill in the art of multi-media software programming would be able to determine the specific encoded frame information that would need to be changed to make it impossible to decode a frame.

In one embodiment, where the frame data is copied by the decoder, the frame is altered upon completion of the encoded frame transfer to the decoder. In another embodiment, the encoded frame is altered when an indication is received that the encoded frame data has been decoded. In another embodiment, only the encoded I-frame is altered after being transferred to the decoder.

In a step 160, a check is made whether there are any more frames from the digital video source. The check can include but is not limited checking whether the end of file is reached.

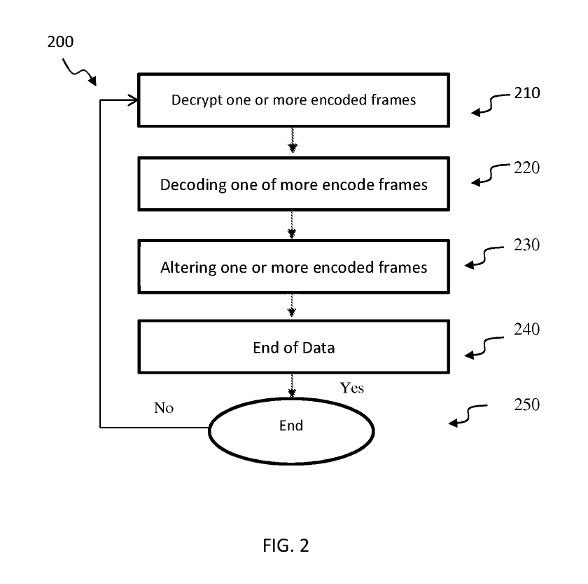

FIG. 2 shows another embodiment of a process of digital rights management of digital video content. In a first step 210, one or more frames of encoded digital data are decrypted. Preferable the encryption and decryption is based on public-key system but other encryption methods are contemplated. In one embodiment, the decryption starts filling the memory buffer with frame data starting with an I-frame and ending at the beginning of the next I-frame.

In a step 220, the one or more encoded frames are decoded. In one embodiment, all of the encoded frames are decoded. In another embodiment, just the buffered I-frame is decoded before altering the I-Frame. While the other encoded frames will need to be decoded, their decoding is not required as a step before altering the I-Frame for this embodiment of the digital rights management.

In a step 230, one or more of the encoded frames are altered. Preferable, the one or more frames are altered such that a copy of the altered encoded frames cannot be decoded. In another embodiment, just the encoded I-frame in the memory buffer is altered to the point where the encoded I-frame(s) cannot be decoded.

In a step 240, a check made whether there are any more frames from the digital video source. The check can include but is not limited checking whether the reading from a file does not return data. If there is more data in the video source, then more encoded frame are decrypted in repeating step 210. In a step 250 the process ends.

Two configurations of a system incorporate the inventive aspects of digital rights management system for a digital video content. The first system has the video playback application already installed into the system. Another element decrypts that digital video and provides it to the video playback application.

In a second embodiment of the system, the decryption software and the video decoding software are integrated together. Thus, there can be a tighter integration of the decrypting of data and the processing of the data.

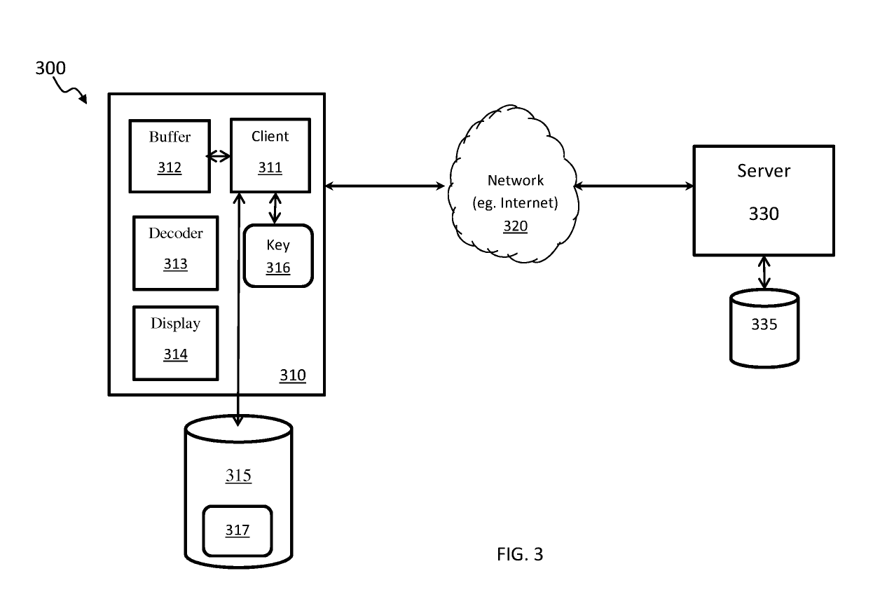

FIG. 3 is exemplar of a system 300 implementing DRM. The system is comprised of a computer 310 that implements the DRM and a server 330 that provides encrypted digital video content 335 over a global network 320. Further the server 330 can provide installable clients 311 for the computer 310 to implement the DRM.

The computer 310 is comprised of a client 311, a memory buffer 312, a video decoder 313, a display 314 for decoded video information, and storage 315 as a source for of encrypted video content 319 downloaded from the server 330.

The client 311 is downloaded from the server 330. The client and the server exchange an encryption key 316 that is unique to the client 311 and thus to the computer 310 on which the client 311 is installed. The client receives encrypted video files 335 from the server 330. The video files 335 are encrypted in a manner that can be decrypted with the encryption key 310. Preferably public-key encryption is used but other encryption means are contemplated. The encryption key is unique to the computer 310 and thus a user. This prevents different client on a different computer from accessing and playing the encrypted video file 317.

The encrypted video files 335 are controlled by the server 330 and downloaded and stored on a storage media 315 are accessible by the computer 310.

The client 311 receives and stores the encrypted file 335 in an accessible storage media 315. This media includes but is not limited to disk drive and solid state storage. Preferable the storage 315 is accessible when the computer 310 is not coupled to the network 320 and the video file 317 is stored in an encrypted format that can be decrypted by the decryption key 316. Further, the encrypted data comprises encoded frames that are encoded in a manner compatible with decoding by the decoder 313. Preferable, the video file 317 is encoded in a format that meets the encoding standards of either MEPG-2, MPEG-4, MPEG-AVC, AVI, H.263 or H.264.

When the encrypted encoded video file 317 is to be played, the client 311 reads encrypted data 313 from the storage media 315. The data is decrypted and stored in a memory buffer 312. Preferably one or more encoded frames of data are read from the buffer. The first encoded frame in the buffer can be an encoded frame representing a full frame of video, sometimes referred to as an I-frame. One or more of these frames are passed to the decoder software 313 by the client 311.

The decoder software 313 decodes the encode frames. The decoder software 313 can provide an indication to the client which encoded frame is decoded and can be overwritten or remove. The indication can include an operating system message, semaphores, function return values, or estimating the time it should take to process the frame. The decoder 313 can be implemented by the computer's CPU or by a graphics processor that is part of the computer 310.

The client 311 is configure to prevent the encoded frames in the memory buffer 312 from being copied by other programs and thus provided controlled access to the encoded video data. The longer the encoded video frames are in the buffer, the greater the possibility that they can be copied. Thus, the client 311 is configured to alter the encoded frames after use by the decoder 313. The encoded frames can be provided by the client to the decoder one at a time or multiple frames at one time. Because of the way the frames are decoded, an encoded B-frame may not be decoded until after the subsequent encode P-frame is decoded. Thus, the client 311 may need to track the processing of multiple encode frames.

If memory buffer 312 contains the I-frame and all subsequent frames up to the next I-frame, then all of the encoded frames can be deleted or altered. Alternatively, once the I-frame is received by the decoder, it can be immediately decoded. Thus, once the I-frame is passed to the decoder 313, the encoded I-frame can be immediately altered to an non-decodable state.

The alteration of the encoded frames can be by overwriting the memory buffer 312 with a new encoded frame, a series of encoded frames, or a series of encoded frames where the encoded frames start with the I-frame and include all the encoded fames up to the next encoded I-frame.

The decoded frames are output to display electronics 314 that displays the encoded video. The display electronics 314 can include a flat panel display of CRT device.

### OPERATIONAL EXAMPLE

In one embodiment of the invention, the system operates as described below. In operation, client is installed on a computer. The client is configured with a unique identifier with an associated encryption key. Preferably, the encryption key is based on public key cryptography. An encrypted video file that can be decrypted with the associated encryption key is stored on a media accessible by the computer. Preferably the video data complies with the video encoding standards for MPEG-2, MPEG-4, MPEG-4 AVC, and H.263, H.264. These standards are defined by the ISO/IEC Moving Picture Experts Group (MPEG) (ISO/IEC JTC1/SC29/WG11) under the formal standard ISO/IEC 14496.

When a user invokes a program to play the video, the client performs a encoded frame by encoded frame decryption of the video data within the video file. The client can have the video decoding software built into the client or can provide frame data to an application the video data.

The encrypted video data is decrypted into one or more encoded frames to prevent another program from copying the decrypted data and thus thwarting the digital rights management. The beginning of the encrypted video file is decrypted and searched for the beginning of a full video frame. For the MPEG standard, this frame is one of an I-Frame.

For systems where the video decoder in not built into the client, the decrypted video file is buffered for only one frame, be it an I, P, or B-frame. The buffered data is passed to video decoding application. If the data is passed to the decoder and video display application by copying, then the buffer of video data is altered as soon as possible after transfer to prevent other applications from copying the data and make unauthorized use of the data. The alterations can be performed by overwriting the frame of encoded video data or writing the next encoded frame of decrypted video data over the top of the data in the buffer.

For system where the video decoder is part of the client, the timing of when an encoded frame is decoded does not match when it is received from the encoded video source. As discussed above, the decoder may receive an encoded B-frame but have to wait for a subsequence encoded P-frame to be received and decoded before the B-frame can be decoder and the encoded B-frame information altered. More advanced compression techniques can use future and past full video frames (I-frames) to encode a P-frame or B-frames. Thus, the memory buffer needs to hold all the encoded data needed to decode all the non-full video frames (P-frames and B-frames).

Thus, care must be taken in the deletion or modification of the buffered encoded frames. While the I-frame may be the first to be decoded, the subsequent frames decrypted are not likely to be the next frame decoded. This is not an issue when each frame is passed to the decoder and it copies the data and manages its own buffers. However, when the decoder and the encryption software is within the same application, care must be taken in overwriting the memory buffer.

One embodiment of the digital rights management is to immediately modify the full video frame or I frame as soon as it is decoded. One method of modifying the frame is to decrypt the next transmitted frame into the memory buffer thereby overwriting the previous frame. However, this frame may be another encoded full video frame and could be larger than the last full video frame given that the I-frames can be different sizes. Thus, there are two options. One is to structure the memory buffer in two segments. The first segment is as large as the largest possible encoded I-frame. The second part of the buffer is for all the encoded frames between the I-frame and the next I-frame.

Though, an encoded I-frame does not depend on any of the other encoded frames. Thus, once the encoded I-frame is decoded into an I-frame, the encoded I-frame can be deleted or otherwise altered to be non-decodable. Without the encoded I-frame(s), any copying of the P/B frames is insufficient to generate corresponding video frames.

What is claimed is:

1. A method of video content digital rights management on a computer comprising the steps;
decrypting a first encoded frame of video from an encrypted digital video source into a memory buffer;
providing the memory buffer to a video decoder;
decoding the first encoded frame thereby forming a first frame;
decrypting a second encoded frame of video content into the memory buffer upon receiving an indication that the first encoded frame is decoded.

2. The method of claim 1 wherein the encrypted video content is encrypted with a public-key cryptography.

3. The method of claim 2 wherein the encrypted video source is comprised I-frames, P-frames and B-frames.

4. The method of claim 3 wherein the indication that the first encoded frame is decoded occurs either when the memory buffer is copied or the decoder generates the indication.

5. The method of claim 4 wherein the video source is encoded according to MPEG-2, MEPG-4, MPEG-4 AVC, H.264, or AVI standards.

6. A method of video content digital rights management on a computer comprising the steps;
decrypting one or more encoded frames from an encrypted encoded video source into a memory buffer;
decoding from the memory buffer each of the one or more encoded frames;
altering one or more of the encoded frame after decoding, wherein the altering would prevent the subsequent decoding of the frame.

7. The method of claim 6, wherein the decrypting the one or more encoded frames begins with an encoded full video frame.

8. The method of claim 7, wherein the encoded full video frame is an encoded I-frame.

9. The method of claim 7, wherein the altering of the one or more encoded frames is performed by decrypting a new encoded frame into the buffer and thereby overwriting part of the buffer with new video content.

10. The method of claim 8 wherein the altering of the one or more encoded frames is performed by changing data within the full encoded frame.

11. The method of claim 6 wherein decoding of the frame generates and an indication of the generating a decoded frame and wherein the alteration of the one or more frames occurs subsequent to the indication and the B-frame data is overwritten.

12. The method of claim 9 wherein the decryption is based on public-key encryption.

13. A system for digital rights management comprising:
a computer configured with a client having a unique computer associated decryption key;
a computer accessible media source configured with an encrypted encoded video file;
a memory buffer; and
a video decoder, wherein the client is configure to decrypt one encoded frame at a time into the memory buffer, transfer the data to the video decoder, and alter the encoded frame data after transfer to the video decoder.

14. The system of claim 13 wherein the client is configured to decrypt and overwrite the buffer with a second encoded frame after the one encoded frame in the buffer is transferred to the video decoder.

15. The system of claim 13 wherein the encoded frame is an I-frame, P-frame, or B-frame.

16. The system of claim 15 wherein the client is configured to alter only the encoded I-frame and wherein the client is configure to modify the encoded I-frame such that it cannot be decoded.

17. A system for digital rights management comprising:
a computer configured with a client having a unique computer associated decryption key;
a computer accessible media source configured with an encrypted encoded video file;
a memory buffer; and
a video decoder, wherein the client is configure to decrypt one or more encoded frames into the memory buffer, wherein the decoder is configured to decode the one or more encoded frame and configured to alter one or more of the one or more encoded frames after decoding one or more of the one or more encoded frames.

18. The system of claim 17, wherein the client is configured to have the first frame in the memory buffer to be an encoded I-frame.

19. The system of claim 18, wherein the altering the one or more of the one or more encoded frames is by the client being configured to load a new encoded I-frame into the memory buffer.

20. The system of claim 18, wherein the wherein the altering modifies the first encoded frame in the memory buffer such that the first encoded frame cannot be decoded.

21. The system of claim 20, wherein the encrypted video source uses public key encryption.
